(19) United States
(12) Patent Application Publication
(10) Pub. No.: US 2022/0198496 A1
(43) Pub. Date: Jun. 23, 2022

(54) PRODUCT PRICING SYSTEM AND METHOD THEREOF

(71) Applicant: FASHIONPHILE Group, LLC, Carlsbad, CA (US)

(72) Inventors: Sarah Davis, Carlsbad, CA (US); Ben Hemminger, Carlsbad, CA (US)

(73) Assignee: FASHIONPHILE Group, LLC, Carlsbad, CA (US)

(21) Appl. No.: 17/603,272

(22) PCT Filed: Aug. 13, 2020
(86) PCT No.: PCT/US20/46246

§ 371 Date: Oct. 12, 2021

Related U.S. Application Data
(60) Provisional application No. 62/886,008, filed on Aug. 13, 2019.

(51) Int. Cl. G06Q 30/02

(52) U.S. Cl. CPC G06Q 30/0206; G06Q 30/0278

(57) ABSTRACT

A product pricing system receives product data associated with a candidate product. The product data includes a product designation and a first product attribute. The first product attribute is one of a plurality of different product attributes associated with a product attribute type. The product pricing system retrieves historical product data associated with a first plurality of previously sold products having the first product attribute from a historical product database. The historical product data includes a product price associated with each of the first plurality of previously sold products. The product pricing system generates a historical product data set including the first plurality of previously sold products, generates a candidate product price based on an average of the product prices associated with the first plurality of previously sold products in the historical product data set, and assigns the candidate product price to the candidate product.

### CROSS-REFERENCE TO RELATED APPLICATIONS

This application claims benefit of priority with PCT International Application PCT/US20/46246, filed Aug. 13, 2020, titled “PRODUCT PRICING SYSTEM AND METHOD THEREOF”; which further claims benefit of priority with U.S. Provisional Application Ser. No. 62/886,008, filed Aug. 13, 2019, titled “SYSTEM & METHOD FOR PRICING FASHION PRODUCTS”; the entire contents of each of which is hereby incorporated by reference.

### TECHNICAL FIELD

This invention relates to computerized methods for pricing products for purchase and/or sell.

### BACKGROUND ART

An increasing number of retailers are involved in the purchase and resale of used products. Examples of such products may include high end fashion products, such as purses, watches, shoes, and other accessories. When a retailer receives information regarding a candidate product that is available for purchase and resale, the retailer often manually estimates a purchase price and a resale price for the candidate product based on personal experience with the purchase and resale of similar products.

In many instances, the manually estimated purchase price and resale price determined by the retailer may not account for differences in condition between the candidate product and previously purchased/previously sold similar products. In some cases, the manually estimated purchase and resale prices may not reflect differences associated with the time period when the previously purchase/previously sold similar products were purchased/sold when compared to the time period when the purchase price/sale price of the candidate product is being set.

### SUMMARY OF INVENTION

### Technical Problem

Many industries, including fashion, are suffering from limitations imposed by antiquated processes, and reliance on human skill. Human skill varies between individuals, and therefore the act of pricing fashion and similar products is conventionally inconsistent among human actors and limited to the skill and training of the actors involved in product pricing.

### Solution to Problem

With the advent of computers, software solutions, and machine learning, comes access to the building blocks required to develop new automated processes, such as processes useful for informing an individual actor concerning historical and/or current value of various products, processes that modify such historical and/or current data with weighted factors for creating an informed buy and/or sell price threshold, and other processes as described herein, wherein the processes are capable of improving pricing consistency, whether buy or sell pricing, and reducing the amount of required training of a human actor for purposes of determining a buy and/or sell price for a particular item.

The invention is directed to a pricing tool and related method, which comprises of a series of steps configured to be performed by a computerized system, which series of steps includes: inputting data, such as a photograph, text or other information describing a product into the computerized system, looking up pricing and other information corresponding to related products that is stored on a database, weighting select factors to compensate for market dynamics and other variables, and transforming the inputted data into a pricing result that informs a human actor of a current buy and/or sell price for the particular product of the inputted data in order to achieve precision and consistency with respect to pricing of the product. Other features and benefits will be recognized by one having skill in the art upon a review of the instant disclosure.

### Advantageous Effects of Invention

In certain embodiments, actors within an organization can use the system and methods herein to obtain current, accurate, and market-adjusted pricing information for guiding transactions related to the purchase and sale of fashion-related items, such as, without limitation, handbags, shoes, time pieces, and other fashion accessories.

Human error related to subjective pricing is attenuated when the human actor is guided using the system and methods herein.

Certain sub-markets, such as the online resale market related to luxury handbags, are stabilized with use of the system and methods herein.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 is a block diagram representation of an embodiment of a product pricing system;

FIG. 2 is a flow chart representation of an example of a method of using an embodiment of the product pricing system to generate a historical product data set;

FIG. 3. is an example of a display of the previously sold products in the historical product data set;

FIG. 4 is a flow chart representation of an example of a method of using the product pricing system to generate a candidate product price for a candidate product based on a historical product data set of previously sold products;

FIG. 5 is a flow chart illustrating a method for obtaining a returned price from inputted product information in accordance with an embodiment; and

FIG. 6 is a diagram illustrating logic flow for calculating a base average for use with the process illustrated in FIG. 5.

### DETAILED DESCRIPTION

In an embodiment, one or more computer storage media having computer-executable instructions that, upon execution by a processor, cause the processor to: receive product data associated with a candidate product, the product data comprising a product designation and a first product attribute, the first product attribute being one of a plurality of different product attributes associated with a product attribute type, retrieve historical product data associated with a first plurality of previously sold products having the first product attribute from a historical product database, the historical product data comprising a product price associated with each of the first plurality of previously sold products, generate a historical product data set comprising the first plurality of previously sold products, determine a candidate product price based on an average of the product prices associated with the first plurality of previously sold products in the historical product data set, and assign the candidate product price to the candidate product.

In an embodiment, a computerized method includes receiving product data associated with a candidate product, the product data comprising a product designation and a first product attribute, the first product attribute being one of a plurality of different product attributes associated with a product attribute type, retrieving historical product data associated with a first plurality of previously sold products having the first product attribute from a historical product database, the historical product data comprising a product price associated with each of the first plurality of previously sold products, generating a historical product data set comprising the first plurality of previously sold products, generating a candidate product price based on an average of the product prices associated with the first plurality of previously sold products in the historical product data set, and assigning the candidate product price to the candidate product.

An electronic device includes at least one processor configured to be communicatively coupled to a display unit and at least one user input device and at least one memory comprising computer program code. The at least one memory and the computer program code configured to, with the at least one processor to cause the electronic device to: receive product data associated with a candidate product via the at least one user input device, the product data comprising a product designation and a first product attribute, the first product attribute being one of a plurality of different product attributes associated with a product attribute type, retrieve historical product data associated with a first plurality of previously sold products having the first product attribute from a historical product database, the historical product data comprising a product price associated with each of the first plurality of previously sold products, generate a historical product data set comprising the first plurality of previously sold products, determine a candidate product price based on an average of the product prices associated with the first plurality of previously sold products in the historical product data set, assign the candidate product price to the candidate product; and display the historical product data set, the product data associated with the historical product data set, the candidate product, and the product data associated with the candidate product on the display unit.

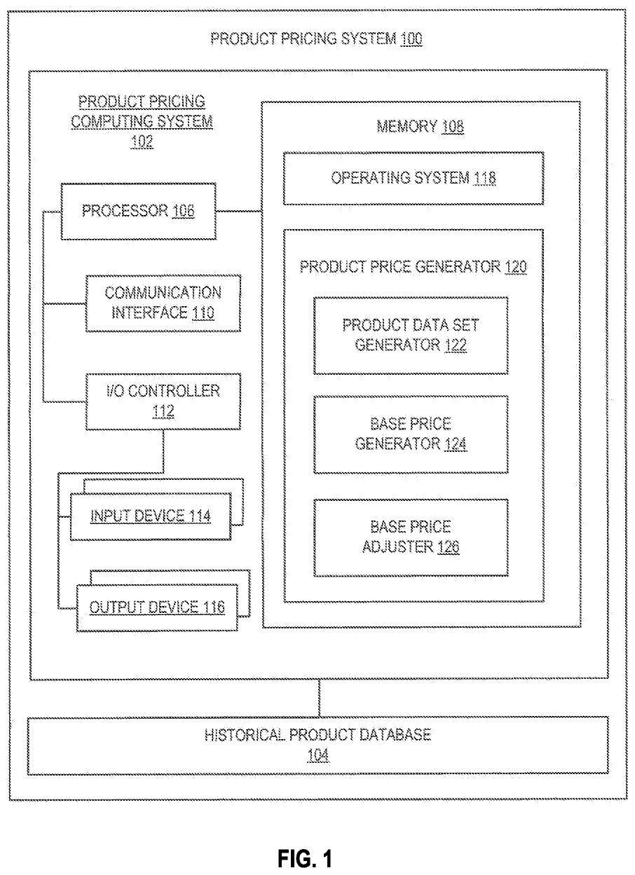

Referring to FIG. 1, an embodiment of a product pricing system 100 is shown. The product pricing system 100 includes a product pricing computing system 102 and a historical product database 104. The product pricing computing system 102 is configured to be communicatively coupled to the historical product database 104. The historical product database 104 is used to store product data associated with previously sold products. The product pricing computing system 102 determines a candidate product price for a candidate product based on a product prices associated previously sold products stored at the historical database 104.

The product pricing computing system 102 may be implemented as a component of an electronic device, a computing system, or a mobile computing system. The product pricing computing system 102 may be implemented as a centralized or a distributed computing system. The product pricing computing system 102 may be located locally or remotely. The product pricing computing system 102 may be accessible via a network or other communication link.

The historical product database 104 may include, for example, computer storage medium such as volatile and non-volatile, removable and non-removable media implemented in any method or technology for storage of information such as computer readable instructions, data structures, program modules or the like. The computer storage medium includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by product pricing computing system 102. The computer storage medium should not be interpreted to be a propagating signal. The historical product database 104 may include computer executable instructions that may be provided using any computer-readable media that are accessible by the product pricing computing system 102.

The product pricing computing system 102 includes at least one processor 106, at least one memory 108, a communication interface 110, an input/output controller 112, at least one input device 114, and at least one output device 116. The at least one processor 106 may be microprocessors, controllers or any other suitable type of processors for processing computer executable instructions to control the operation of the product pricing computing system 102.

The at least one memory 108 may include, for example, computer storage medium such as volatile and non-volatile, removable and non-removable media implemented in any method or technology for storage of information such as computer readable instructions, data structures, program modules or the like. The computer storage medium includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by the at least one processor 106. The computer storage medium should not be interpreted to be a propagating signal. The at least one memory 108 includes computer executable instructions that may be provided using any computer-readable media that is accessible by the at least one processor 106. Although the at least one memory 108 is shown within the product computing pricing system 102, it will be appreciated by a person skilled in the art, that the at least one memory 108 may be distributed or located remotely and accessed via a network or other communication link.

The communication interface 110 is configured to enable the product pricing computing system 102 to receive data via a network or other type of communication link. The input/output controller 112 is configured to be communicatively coupled to the at least one input device 114. Examples of input devices 114 include, but are not limited to, a keyboard, a microphone, and a touchpad. The at least one input device 114 may be separate from product pricing computing system 102 or integral with the product pricing computing system 102.

The input/output controller 112 is configured to be communicatively coupled to the at least one output device 116. Examples of output devices 116, include but are not limited to a display, a speaker, and a printer. The at least one output device 116 may be separate from product pricing computing system 102 or integral with the product pricing computing system 102. In an embodiment, the output device 116 may be integrated with the input device 114. An example of an integrated input/output device is a touch sensitive display screen.

An operating system 118 and a product price generator 120 are stored in the at least one memory 108. The operating system 118 enables the product price generator 120 to be executed on the product pricing computing system 102. The product price generator 120 includes a product data set generator 122, a base price generator 124, and a base price adjuster 126. The product price generator 120 may include additional components that facilitate the performance of the product price generator 120.

The functionality described herein can be performed, at least in part, by one or more hardware logic components. According to an embodiment, the product pricing computing system 102 is configured by the program code when executed by the processor 106 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

While a number of different components of the product pricing system 100 have been described, the product pricing system 100 may include additional components that may facilitate the operation of the product pricing system 100.

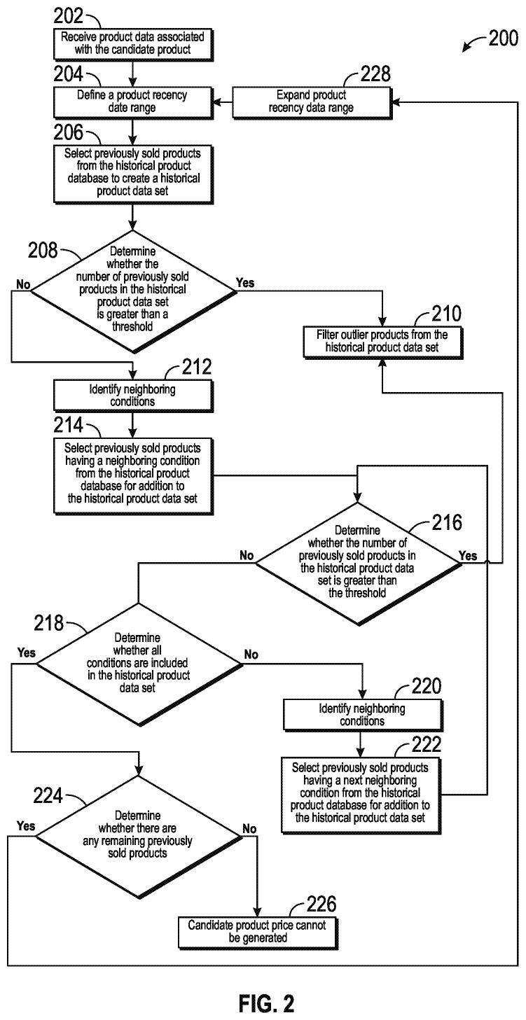

Referring to FIG. 2 a flow chart representation of an example of a method 200 of using an embodiment of the product pricing system 100 to generate a historical product data set of previously sold products to determine the candidate product price for a candidate product is shown. Examples of candidate products include, but are not limited to purses, watches, shoes, and other types of accessories. Product data associated with the candidate product is received at the product pricing system 100 at 202. In an embodiment, the product data associated with the candidate product is received via a user interface. In an embodiment, the product data associated with the candidate product is received via a communication interface that is communicatively coupled to a network. Examples of product data include, but is not limited to, a product designation and a product attribute.

The product designation includes one or more of a product title, a product image, a product manufacturer, a product type, a product model, and a product model year. The product attribute types include, but are not limited to, a product condition and a product recency date.

In an embodiment, the product condition may be one of a new condition, an excellent condition, a very good condition, a good condition, a fair condition, and a poor condition. For example, the candidate product that is received for pricing may be assessed to be in a good condition. While a number of different product conditions have been described, other types of product condition may be used.

The product recency date is one of the date the product is/was priced, the date the product was offered for sale, and the date the product was sold. In an embodiment, the product recency date for the candidate product is the date that the candidate product is being priced. The product data set generator 122 defines a product recency date range at 204. The product recency date range is relative to the product recency date of the candidate product. For example, the product data set generator 122 may define a product recency date range from the product recency date of the candidate product to 90 days prior to the product recency date of the candidate product, where the product recency date of the candidate product is the date that the candidate product is being priced.

The historical product database 104 is used to store product data associated with previously sold products. The product data associated with previously sold products may also be referred to as historical product data. The stored historical product data includes the product designation and the product attributes for each of the previously sold products. The stored product attributes include the product condition and one or more product recency dates for each of the previously sold products.

The product designation includes one or more of a product title, a product image, a product manufacturer, a product type, a product model, and a product model year for each of the previously sold products. The product condition of each of the previously sold products may be one of a new condition, an excellent condition, a very good condition, a good condition, a fair condition, and a poor condition. The product recency date of each of the previously sold products includes one or more of the date the previously sold product was priced, the date the previously sold product was offered for sale, and the date the previously sold product was sold.

The product data set generator 122 selects the previously sold products from the historical database 104 that have one or more of the same product designations as the candidate product, the same product condition as the candidate product, and that fall within the established product recency date range to create a historical product data set at 206. A user is provided with the option of defining the specific product designation for the product data set generator 122 to use in the selection process.

For example, the candidate product may be a candidate Brand A purse that is assessed to be in a good condition and has a product recency date of the date that the candidate Brand A purse is being priced. In this example, the product data set generator 122 identifies the previously sold Brand A purses that were in a good condition, have a product recency date (for example a product sale date) that falls within the time period ranging from the product recency date of the candidate Brand A purse to 90 days before the product recency date of the candidate Brand A purse. The product recency date is the date that the candidate Brand A purse is being priced. The product data set generator 122 uses the selected previously sold Brand A purses to create the historical product data set.

The product data set generator 122 determines whether the number of previously sold products in the historical product data set exceeds a minimum threshold number at 208. If the product data set generator 122 determines that the number of previously sold products in the historical data set of previously sold products exceeds a minimum threshold number, the product data set generator 122 filters outlier products from the historical product data set at 210. The product price computing system 102 uses the filtered historical product data set to set the candidate product price.

In an embodiment, the product pricing computing system 102 provides a user with an option of manually excluding outlier products from the historical product data set via a user interface. For example, the product pricing computing system 102 may display the historical product data set on a screen. A user may review the historical product data set displayed on the screen and selectively remove the outlier products from the historical product data set via the user interface.

In an embodiment, the product pricing computing system 102 automatically filters outlier products from the historical data set. In an embodiment, outlier products are identified as those previously sold products that have a two score of three or more for the price field. In an embodiment, those previously sold products that have a z-score of more than three are considered outliers and automatically excluded.

If the product data set generator 122 determines that the number of previously sold products in the historical product data set does not exceed the minimum threshold number at 208, the product data set generator 122 identifies neighboring product conditions based on the product condition of candidate product at 212. For example, when the product condition of the candidate product is assessed to be in a good condition, the neighboring product conditions are a very good condition and a fair condition.

The product data set generator 122 selects the previously sold products in the historical product database 104 that have the same product designation as the candidate product, the identified neighboring conditions and that fall within the product recency date range for addition to the historical product data set at 214. For example, the product data set generator 122 selects the previously sold Brand A purses that are in a fair condition and in a very good condition that were sold during the product recency date range extending from the product recency date of the candidate Brand A purse to 90 days prior to the product recency date of the candidate Brand A purse.

The product dataset generator 122 determines whether the number of previously sold products in the historical product data set exceeds the minimum threshold number at 216. If the product dataset generator 122 determines that the number of previously sold products in the historical product data set of previously sold products exceeds the minimum threshold number, the product data set generator 122 filters outlier products from the historical product data set at 210. The product price computing system 102 uses the filtered historical product data set to set the candidate product price.

If the product data set generator 122 determines that the number of previously sold products in the historical product data set of does not exceed the minimum threshold number at 216, the product data set generator 122 determines whether all of the possible product conditions have been included in the historical product data set at 218.

If the product data set generator 122 determines that all of the possible product conditions have not been included in the historical product data set, the product data set generator 122 identifies the next neighboring product conditions based on the previously identified neighboring product conditions at 220. For example, when the previously identified neighboring product conditions are a very good condition and a fair condition, the next neighboring product conditions are an excellent condition and a poor condition.

The product data set generator 122 selects the previously sold products in the historical product database 104 that have the same product designation as the candidate product, the identified next neighboring conditions and that fall within the product recency date range for addition to the historical product data set at 222.

The product dataset generator 122 determines whether the number of previously sold products in the historical product data set exceeds the minimum threshold number at 216. If the product dataset generator 122 determines that the number of previously sold products in the historical product data set of previously sold products exceeds the minimum threshold number, the product data set generator 122 filters outlier products from the historical product data set at 210. The product price computing system 102 uses the filtered historical product data set to set the candidate product price.

If at 218, the product data set generator 122 determines that all of the possible product conditions have been included in the historical product data set, the product data set generator 122 determines whether there are additional previously sold products having the same product designation as the candidate product stored in the historical data set at 224. If the product data set generator 122 determines that there are no additional previously sold products having the same product designation as the candidate product stored in the historical data set, the product price generator 120 determines that a price cannot be generated for the candidate product at 226.

If at 224, the product data set generator 122 determines that there are additional previously sold products having the same product designation as the candidate product stored in the historical product database 104, the product data set generator 122 expands the product recency date range at 228. The method 200 returns to 204 where the expanded product recency date is defined as the product recency date range.

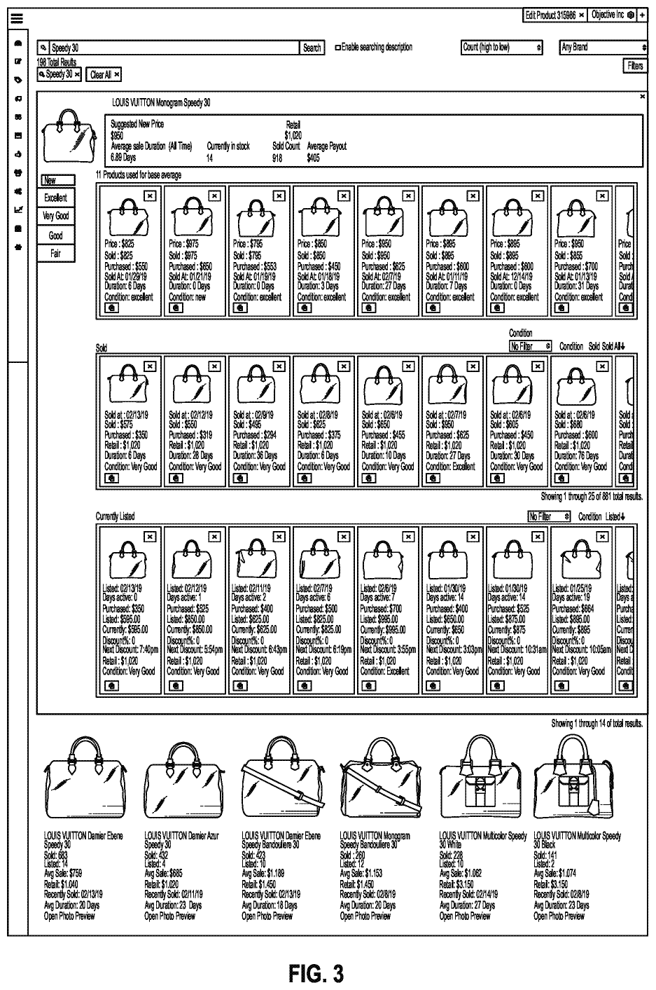

Referring to FIG. 3, an example of a display of the historical product data set of previously sold products is shown. The candidate product in the illustrated example is a purse. In a graphical user interface such as the one illustrated in FIG.3, a human actor is able to view and select individual records each containing historical product data for one transaction, or the human actor may modify selection criteria from a plurality of options, including condition (ex: ‘excellent’, ‘very good’, ‘good’, ‘fair’), brand identifier, sorting value high to low or low to high, searching keywords, and the like.

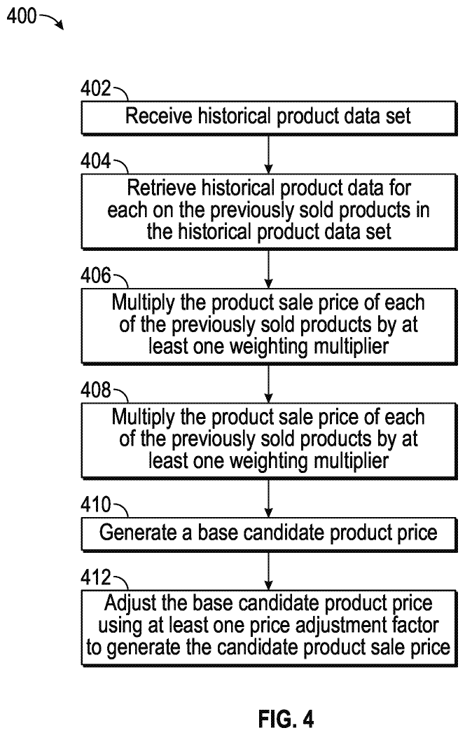

Referring to FIG. 4, an example of a method 400 of using an embodiment of the product pricing system 100 to generate a price for a candidate product using a historical product data set of previously sold products is shown.

The historical product data set generated by the product dataset generator 122 is received by the base price generator 124 at 402. The base price generator 124 retrieves the historical product data for each of the previously sold products in the historical product data set at 404. In an embodiment, the retrieved historical product data includes the product sale price, the product condition, and the product recency date for each of the previously sold products In an embodiment, the product recency date is the date that the date that the previously sold product was sold.

The base price generator 124 multiplies the product sale price of each of the previously sold products using at least one weighting multiplier at 406. The weighting multiplier is used to multiply the sale price of each of the previously sold products so that the weighted sale price reflects product attribute differences between the previously sold products and the candidate product. In other words, the sale price of the previously sold products are normalized with respect to the product attributes of the candidate product. In an embodiment, the product sale price for each of the previously sold products is multiplied using a product condition weighting multiplier. In an embodiment, the product sale price for each of the previously sold products is multiplied using a product recency weighting multiplier. In an embodiment, the product sale price for each of the previously sold products is multiplied using a product condition multiplier and a product recency multiplier.

For example, if the candidate product is in a good condition and a previously sold product was in a very good product condition and has product sale date of 180 days ago, the previously sold product sale price is multiplied by a product condition multiplier and a product recency multiplier. The product condition multiplier is used to weight the sale price so that the weighted sale price is comparable to the good product condition of the candidate product. The product recency multiplier is used to weight the sale price so that the weighted sale price is comparable to a relatively more recent sale of, such as for example, 90 days.

In an embodiment, a weighting multiplier is used to multiply the sale price of each of the previously sold products so that the weighted sale price is adjusted for product designation differences between the previously sold products and the candidate product. Examples of such weighting multipliers including a product title weighting multiplier and a product brand weighting multiplier. One or more of the product condition weighting multiplier, product recency weighting multiplier, the product title weighting multiplier, and the product brand weighting multiplier may be used to multiply the sale price of each of the previously sold products so that the weighted sale price reflects differences between the previously sold products and the candidate product

The base price generator 124 uses the weighted sales prices of the previously sold products in the historical product data set to generate a base candidate product price at 408. In an embodiment the price generator 124 calculates a simple average of the weighted sale prices of the previously sold products in the historical product data set to generate base candidate product price. In an embodiment, the base candidate product price used to set the sale price of the candidate product.

In an embodiment, the base price adjuster 126 adjusts the base candidate product price generated by the base price generator 124 using at least one price adjustment factor to generate the candidate product sale price at 408. A user is provided with the option of selectively defining one or more price adjustment factors based on one or more different factors. Examples of price adjustment factors include, but are not limited to, a product title adjustment factor, a product brand adjustment factor, number of product in stock adjustment factor, percentage product returned adjustment factor, an average product sale duration adjustment factor, and a percentage currently discounted adjustment factor.

For example, if previously sold products that are comparable to the candidate product have an average sales duration of more than 30 days, the base candidate product price may be adjusted using the average product sale duration adjustment factor. The average product sale duration adjustment factor may, for example, be a multiplier that lowers the base candidate product price by −10% to reflect the average sales duration period.

In an embodiment, the product pricing computing system 102 includes a sales duration alert setting. The sale duration alert setting is configured to alert buyers when the average sale duration falls below a pre-defined average sale duration threshold The sale duration alert setting enables a user to maintain up to date average sale duration data associated with products that are offered for sale. The sale duration alert setting also enable the user to maintain up to average sale duration thresholds. In an embodiment, the sale duration alert setting generates notifications to the user to assist the user in keeping the sale duration for products that are offered for sale via the product pricing system 100 within specific sale duration targets associated with the product.

In an embodiment the product pricing system 100 may be used to determine a product purchase price of the candidate product based on historical product data associated with the purchase price of previously purchased products. The historical product data associated with previously purchase products are stored in the historical product data base 104. This historical product database includes the product purchase price for each of the previously purchased products. The product data set generator 122 utilizes the techniques described above to generate a historical product data set of previously purchase products in a manner similar to that described with reference to FIG. 2. The base price generator 124 utilizes the historical product data set to generate a base purchase price of the candidate product in a manner similar to that described with reference to FIG. 4. In an embodiment, the base purchase price is used to set the candidate product purchase price. In an embodiment, the base price adjuster 126 adjusts the base purchase price in a manner similar to that described with reference to FIG. 4. The adjusted base purchase price is used to set the candidate product purchase price.

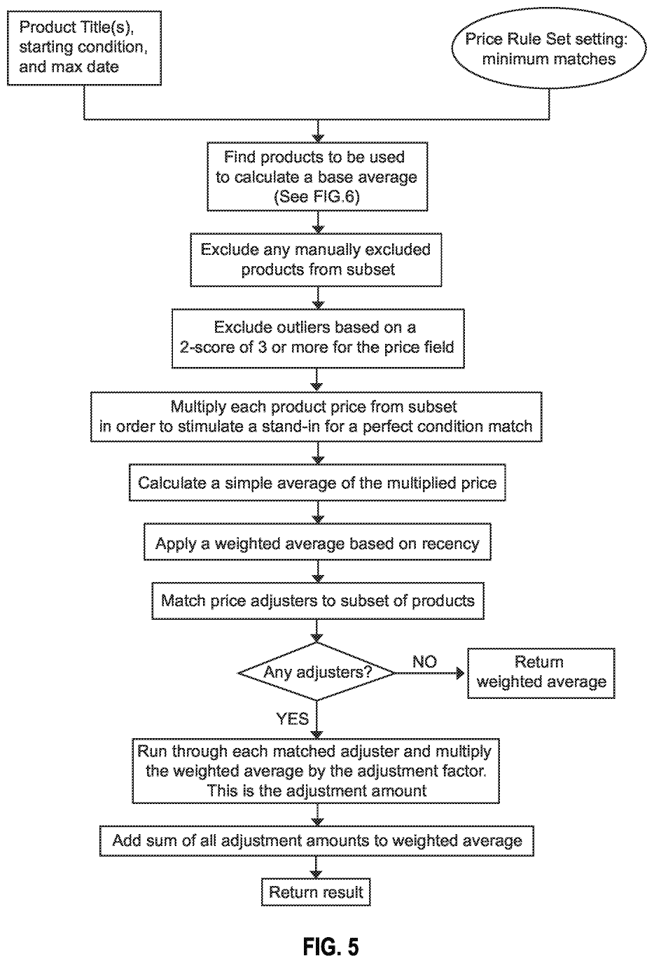

Now turning to FIG. 5, an exemplary method is illustrated, comprising the steps:

Step 1: Obtain Product Titles(s), starting condition, and max date. The condition may be: “new”, “excellent”, “very_good”, “good”, or “fair”. Max date is optional and may default to now. Price Rule Set setting is selected to minimum matches.

Step 2: Find products to be used to calculate a base average. Step 2 is further detailed in a series of sub-steps illustrated in FIG. 2.

Step 3: Exclude any manually excluded products from the subset.

Step 4: Exclude outliers based on a 2-score of 3 or more for the price field.

Step 5: Multiply each product price from the subset in order to stimulate a stand-in for a perfect condition match. This step is intended to help cases when we have matched products that are not exactly the same condition as the product that needs to be priced. For example, if we want to price a new handbag, but we only have “very_good” bags to compare to, we might multiply each bag in the subset my 110%.

Step 6: Calculate a simple average of the multiplied price.

Step 7: Apply a weighted average based on recency. The weighted average is a setting that can be defined globally or for groups of products based on any combination of titles, conditions, and brands. Ranges can be defined for days of product recency and a weight that should be used for each product depending on where it falls in the recency scale.

Step 8: Match price adjusters to subset of products. Similar to the weight rules, we match adjusters to products based on any combination of product title, condition, brand, number in stock, percentage returned, average sales duration in days, and percentage discounted. Each matched adjuster will multiple the price by a positive or negative percentage.

Step 9: Determine whether there are any adjusters.

Step 10A: If no adjusters, return weighted average.

Step 10B-1: If adjusters, run through each matched adjuster and multiply the weighted average by the adjustment factor; this is the adjustment amount.

Step 10B-2: add sum of all adjustment amounts to weighted average.

Step 10B-3: return result.

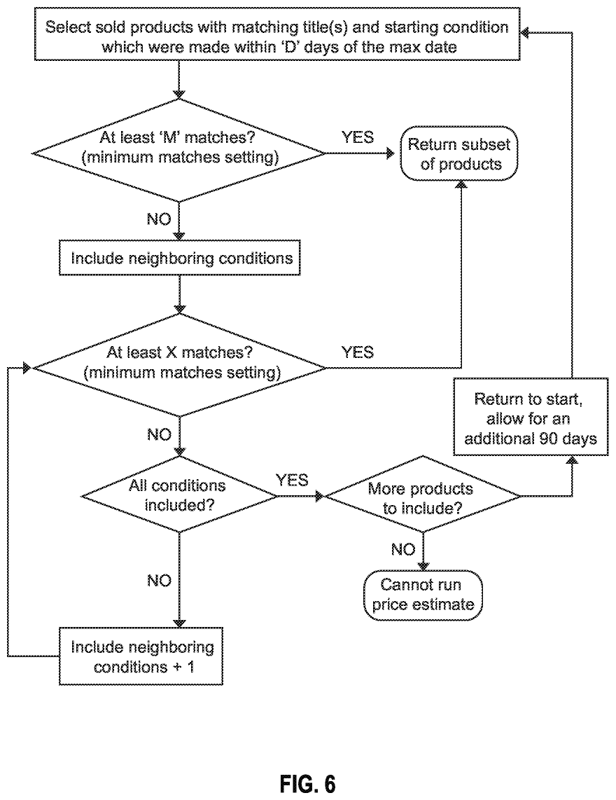

FIG. 6 shows a diagram illustrating logic flow for calculating a base average for use with the process illustrated in FIG. 5.

As illustrated in FIG. 6, the process includes the steps:

Step 1: select sold products with matching title(s) and starting condition which were made within ‘D’ days of the max date.

Step 2: According to the minimum matches setting, are there at least ‘M’ matches?

Step 3A: If at least ‘M’ matches, then return a subset of products.

Step 3B-1: If less than ‘M’ matches, include neighboring conditions.

Step 3B-2: According to the minimum matches setting, are there at least ‘M’ matches?

Step 3B-3A: If at least ‘M’ matches, then return a subset of products.

Step 3B-3B-1: If less than ‘M’ matches, are all conditions included?

Step 3B-3B-2A: if all conditions included, are there more products to include? If so, repeat Step 1 allowing for an additional 90 days of the max date.

Step 3B-3B-2B: if fewer than all conditions included, include [neighboring conditions+1], repeat Step 3B-2.

Any range or device value described herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. One having skill in the art will appreciate that one or more select features or steps of one embodiment may be combined with one or more select features or steps of another embodiment to achieve a pricing tool that uses inputted data and stored historical data, along with instructions, to produce an output pricing data useful for guiding a human actor during a fashion product related transaction.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. One or more computer storage media having computer-executable instructions that, upon execution by a processor, cause the processor to:
receive product data associated with a candidate product, the product data comprising a product designation and a first product attribute, the first product attribute being one of a plurality of different product attributes associated with a product attribute type, wherein the product attribute type comprises a product condition;
retrieve historical product data associated with a first plurality of previously sold products having the first product attribute from a historical product database, the historical product data comprising a product price associated with each of the first plurality of previously sold products;
generate a historical product data set comprising the first plurality of previously sold products;
determine whether a number of previously sold products in the historical product data set is greater than or equal to a minimum threshold number;
retrieve historical product data associated with a second plurality of previously sold products having a second product attribute from the historical product database, the second product attribute being a neighboring product condition;
add the second plurality of previously sold products to the historical product data set;
assign a first weight to the historical product prices associated with the first product attribute and a second weight to the historical product prices associated with the second product attribute;
generate a weighted historical product price for each of the previously sold products in the historical product data set;
determine a candidate product price based on an average of the weighted historical product prices associated with the first plurality of previously sold products and the second plurality of previously sold products in the historical product data set; and
assign the candidate product price to the candidate product.

2. The one or more computer storage media of claim 1, wherein receiving the product designation associated with the candidate product comprises receiving at least one of a product title, a product image, a product manufacturer, a product type, a product model, and a product model year of the candidate product.

3. The one or more computer storage media of claim 1, wherein the first product attribute is selected from a group consisting of a new condition, an excellent condition, a very good condition, a good condition, a fair condition, and a poor condition.

4. The one or more computer storage media of claim 1, further comprising computer executable instructions that, upon execution by the processor, cause the processor to:
retrieve the historical product data associated with the first plurality of previously sold products having a product attribute comprising a product recency date that falls within a product recency date range based on a pricing setting date of the candidate product.

5. The one or more computer storage media of claim 1, further comprising computer executable instructions that, upon execution by the processor, cause the processor to:
determine whether a number of previously sold products in the historical product data set is greater than or equal to a minimum threshold number;
retrieve historical product data associated with a plurality of previously sold products having a next neighboring product condition from the historical product database;
add the plurality of previously sold products having the next neighboring product condition to the historical product data set;
assign a weight to the historical product prices associated with the next neighboring product condition;
generate a weighted historical product price for each of the previously sold products in the historical product data set; and
update the candidate product price assigned to the candidate product based on an average of the weighted historical product prices in the historical data set.

6. The one or more computer storage media of claim 1, further comprising computer executable instructions that, upon execution by the processor, cause the processor to:
remove at least one outlier previously sold product from the historical product data set prior to determining the candidate product price.

7. (canceled)

8. The one or more computer storage media of claim 1, further comprising computer executable instructions that, upon execution by the processor, cause the processor to:
adjust the candidate product price by applying at least one price adjustment factor to the candidate product price; and
updating the candidate product price of the candidate product with the adjusted candidate product price.

9. A computerized method comprising:
receiving product data associated with a candidate product, the product data comprising a product designation and a first product attribute, the first product attribute being one of a plurality of different product attributes associated with a product attribute type, wherein the product attribute type comprises a product condition;
retrieving historical product data associated with a first plurality of previously sold products having the first product attribute from a historical product database, the historical product data comprising a product price associated with each of the first plurality of previously sold products;
generating a historical product data set comprising the first plurality of previously sold products;
determining whether a number of previously sold products in the historical product data set is greater than or equal to a minimum threshold number;
retrieving historical product data associated with a second plurality of previously sold products having a second product attribute from the historical product database, the second product attribute being a neighboring product condition;
adding the second plurality of previously sold products to the historical product data set;
assigning a first weight to the historical product prices associated with the first product attribute and a second weight to the historical product prices associated with the second product attribute;
generating a weighted historical product price for each of the previously sold products in the historical product data set
determining a candidate product price based on an average of the weighted historical product prices associated with the first plurality of previously sold products and the second plurality of previously sold products in the historical product data set; and
assigning the candidate product price to the candidate product.

10. The computerized method of claim 9, wherein receiving the product designation associated with the candidate product comprises receiving at least one of a product title, a product image, a product manufacturer, a product type, a product model, and a product model year of the candidate product.

11. The computerized method of claim 9, wherein the first product attribute is selected from a group consisting of a new condition, an excellent condition, a very good condition, a good condition, a fair condition and a poor condition.

12. The computerized method of claim 9, further comprising:
retrieving the historical product data associated with the first plurality of previously sold products having a product attribute comprising a product recency date that falls within a product recency date range based on a pricing setting date of the candidate product.

13. The computerized method of claim 9, further comprising:
determining whether a number of previously sold products in the historical product data set is greater than or equal to a minimum threshold number;
retrieving historical product data associated with a plurality of previously sold products having a next neighboring product condition from the historical product database;
adding the plurality of previously sold products having the next neighboring product condition to the historical data set;
assigning a weight to the historical product prices associated with the next neighboring product condition;
generating a weighted historical product price for each of the previously sold products in the historical product data set; and
updating the candidate product price assigned to the candidate product based on an average of the weighted historical product prices in the historical data set.

14. The computerized method of claim 9, further comprising removing at least one outlier previously sold product from the historical product data set prior to determining the candidate product price.

15. (canceled)

16. The computerized method of claim 9, further comprising:
adjusting the candidate product price by applying at least one price adjustment factor to the candidate product price; and
updating the candidate product price of the candidate product with the adjusted candidate product price.

17. An electronic device, comprising:
at least one processor configured to be communicatively coupled to a display unit and at least one user input device; and
at least one memory comprising computer program code, the at least one memory and the computer program code configured to, with the at least one processor to cause the electronic device to:
receive product data associated with a candidate product via the at least one user input device, the product data comprising a product designation and a first product attribute, the first product attribute being one of a plurality of different product attributes associated with a product attribute type, wherein the product attribute type comprises a product condition;
retrieve historical product data associated with a first plurality of previously sold products having the first product attribute from a historical product database, the historical product data comprising a product price associated with each of the first plurality of previously sold products;
generate a historical product data set comprising the first plurality of previously sold products;
determine whether a number of previously sold products in the historical product data set is greater than or equal to a minimum threshold number;
retrieve historical product data associated with a second plurality of previously sold products having a second product attribute from the historical product database, the second product attribute being a neighboring product condition;
add the second plurality of previously sold products to the historical product data set;
assign a first weight to the historical product prices associated with the first product attribute and a second weight to the historical product prices associated with the second product attribute;
generate a weighted historical product price for each of the previously sold products in the historical product data set;
determine a candidate product price based on an average of the product prices associated with the first plurality of previously sold products and the second plurality of previously sold products in the historical product data set;
assign the candidate product price to the candidate product; and
display the historical product data set, the product data associated with the historical product data set, the candidate product, and the product data associated with the candidate product on the display unit.

18. The electronic device of claim 17, wherein receiving the product designation associated with the candidate product comprises receiving at least one of a product title, a product image, a product manufacturer, a product type, a product model, and a product model year of the candidate product.

19. The electronic device of claim 17, wherein the first product attribute is selected from a group consisting of a new condition, an excellent condition, a very good condition, a good condition, a fair condition, and a poor condition.

20. The electronic device of claim 17, further comprising computer program code configured to, with the at least one processor to cause the electronic device to:
retrieve the historical product data associated with the first plurality of previously sold products having a product attribute comprising a product recency date that falls within a product recency date range based on a pricing setting date of the candidate product.

21. The electronic device of claim 17, further comprising computer program code configured to, with the at least one processor to cause the electronic device to:
determine whether a number of previously sold products in the historical product data set is greater than or equal to a minimum threshold number;
retrieve historical product data associated with a plurality of previously sold products having a next neighboring product condition from the historical product database add the plurality of previously sold products having the next neighboring product condition to the historical product data set;
assign a weight to the historical product prices associated with the next neighboring product condition;
generate a weighted historical product price for each of the previously sold products in the historical product data set; and
update the candidate product price assigned to the candidate product based on an average of the weighted historical product prices in the historical data set.

22. (canceled)

23. (canceled)

24. The electronic device of claim 17, further comprising computer program code configured to, with the at least one processor to cause the electronic device to:
adjust the candidate product price by applying at least one price adjustment factor to the candidate product price; and
updating the candidate product price of the candidate product with the adjusted candidate product price.
